(19) United States
(12) Patent Application Publication
(10) Pub. No.: US 2024/0119803 A1
(43) Pub. Date: Apr. 11, 2024

(54) SYSTEM AND METHOD FOR HOSTING A REAL-TIME SPORTS CONTEST

(71) Applicant: Mark McNeely, Mercer Island, WA (US)

(72) Inventor: Mark McNeely, Mercer Island, WA (US)

(21) Appl. No.: 18/373,858

(22) Filed: Sep. 27, 2023

Related U.S. Application Data
(60) Provisional application No. 63/413,585, filed on Oct. 5, 2022.

(51) Int. Cl. G07F 17/32; A63F 13/46; G06Q 50/34

(52) U.S. Cl. CPC G07F 17/3288; A63F 13/46; G06Q 50/34; G07F 17/323; G07F 17/3244; G07F 17/326

(57) ABSTRACT

One variation of a method for hosting a real-time sports contest includes, during a live sporting event: transmitting a contest feed to a user portal executing on a mobile device accessed by a user; and tracking a user score. The method further includes, during a pre-play window: generating a prompt to select a predicted outcome, in a set of outcomes, for execution within the live sporting event during a live-play window succeeding the pre-play window; assigning the prompt a reward value; transmitting the prompt to the user via the user portal; and, in response to receiving selection of a first predicted outcome, in the set of outcomes, assigning the first predicted outcome to the user. The method further includes, during the live-play window, in response to the first predicted outcome corresponding to an actual outcome executed during the live-play window, updating the user score based on the reward value.

### CROSS-REFERENCE TO RELATED APPLICATIONS

This application claims the benefit of U.S. Provisional Application No. 63/413,585, filed on 5 Oct. 2022, which is incorporated in its entirety by this reference.

### TECHNICAL FIELD

This invention relates generally to the field of online sports contests and more specifically to a new and useful method for hosting a real-time sports contest in the field of online sports contests.

### BRIEF DESCRIPTION OF THE FIGURES

FIG. 1 is a flowchart representation of a method;

FIGS. 2A and 2B are flowchart representations of the method; and

FIG. 3 is a flowchart representation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

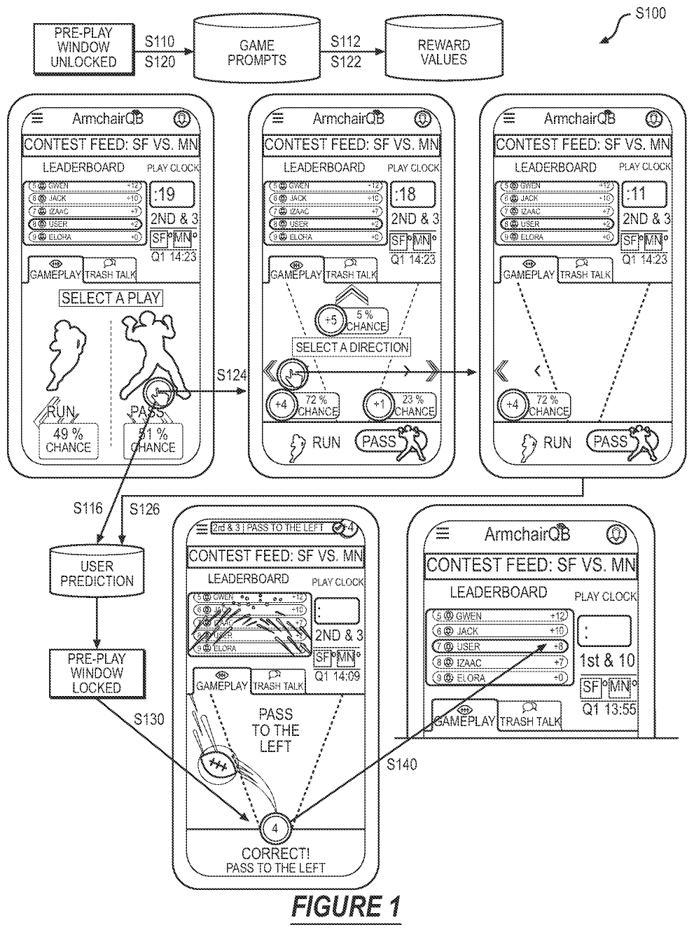

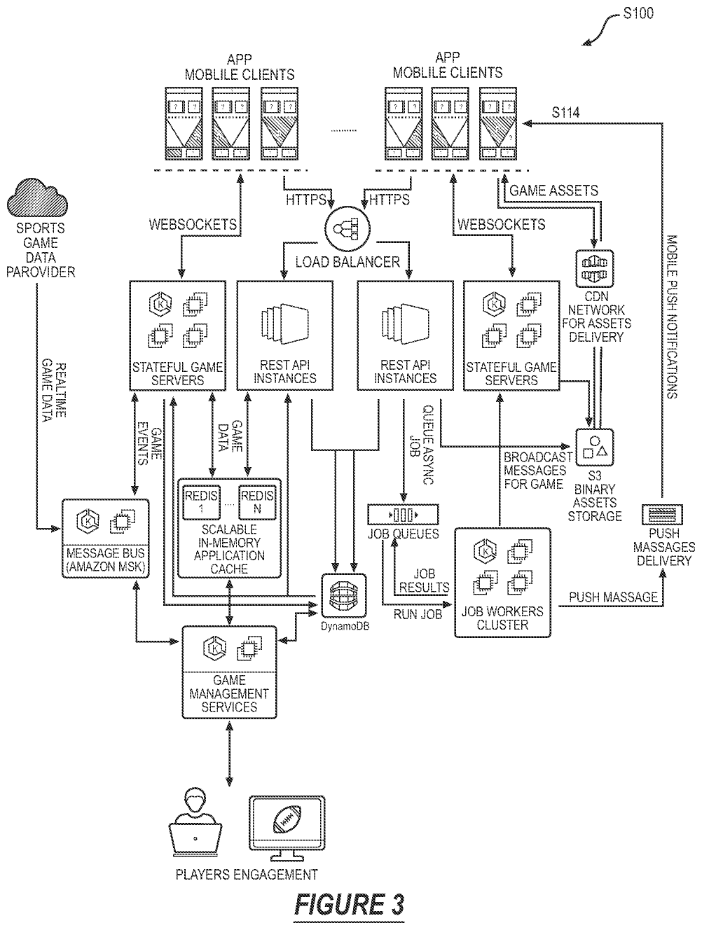

As shown in FIGS. 1-3, a method S100 for hosting a real-time sports contest includes, during a contest period associated with a live sporting event: transmitting a contest feed to a user via an instance of a user portal executing on the mobile device, the contest feed associated with a sporting event in Block S102; and tracking a score of the user based on user interactions with the contest feed in Block S104. The method S100 further includes, during a pre-play window within the contest period: generating a first game prompt to select a first predicted outcome (e.g., passing play), from a first set of outcomes (e.g., passing play, rushing play), for execution within the live sporting event, during a live-play window succeeding the pre-play window in Block S110; assigning the first game prompt a first reward value in Block S112; transmitting the first game prompt to the user within the contest feed via the user portal in Block S114; and, in response to receiving selection of a first predicted outcome, from the first set of outcomes, prior to expiration of the pre-play window, storing the first predicted outcome for the first user in Block S116. The method S100 further includes, during the live-play window succeeding the pre-play window and within the contest period: identifying a first actual outcome (e.g., passing play), from the first set of outcomes, executed within the live sporting event during the live-play window in Block S130; and, in response to the first predicted outcome corresponding to the first actual outcome, updating the score of the user based on the first reward value in Block S140.

In one variation, the method S100 further includes, in response to receiving selection of the first predicted outcome, from the first set of outcomes, prior to expiration of the pre-play window: generating a second game prompt to select a subsequent predicted outcome, from a second set of outcomes (e.g., pass left, pass right), based on the first predicted outcome, for execution within the live sporting event, during the live-play window in Block S120; assigning to the second game prompt a second reward value in Block S122; transmitting the second game prompt to the user within the contest feed via the user portal in Block S124; and, in response to receiving selection of a second predicted outcome (e.g., pass left), from the second set of outcomes, prior to expiration of the pre-play window, storing the second predicted outcome for the first user in Block S126. In this variation, the method S100 includes, in response to the first predicted outcome and the second predicted outcome corresponding to the first actual outcome and the second actual outcome, updating the score of the user based on the first reward value and the second reward value in Block S140.

### 2. Applications

Generally, the method S100 can be executed by a remote computer system (e.g., a computer network, a remote server) in conjunction with a native application to host a real-time, online sports contest. In particular, Blocks of the method S100 can be executed by the remote computer system in cooperation with an instance of the native application (e.g., executing on a user's mobile device) to: synchronize an instance of a contest feed (e.g., viewed within the instance of the native application) to a video stream of a sporting event (e.g., a live football game) viewed by the user; serve game prompts to the user within the synchronized contest feed in (near) real time—such as before, during, and after live gameplay for this sporting event (e.g., as viewed by the user)—for selecting predicted outcomes (e.g., pass, rush, touchdown, fumble) which may occur during gameplay (e.g., during a next play); and selectively distribute rewards assigned to these prompts, to the user, based on actual outcomes performed during gameplay (e.g., by players participating in the live football game). Further, the remote computer system can cooperate with multiple instances of the native application to execute this process for multiple users (e.g., a group of users, a population of users) viewing this live sporting event, thereby enabling users to compete against other users in this real-time sports contest.

For example, the remote computer system can cooperate with an instance of the native application (e.g., executing on a user's smartphone) to synchronize a contest feed to a live football game that this user is watching on another display or outside of the native application. In particular, a user may wish to participate in a contest associated with a live football game. The user may open an instance of the native application on her smartphone and select a contest feed associated with this live football game. The remote computer system can then cooperate with this instance of the native application to temporally synchronize an instance of the contest feed (e.g., served to the first user within the instance of the native application) to a video feed of the live football game displayed on the user's television—such as via detection of an audio footprint in an audio feed output by the user's television or via capture of QR code displayed on the video feed of the football game. During the football game, prior to each individual play, the remote computer system can: unlock a pre-play window for this instance of the contest feed, the pre-play window aligned with a break in play in the video feed of the football game viewed by this user; serve the user a game prompt (e.g., via the first instance of the contest feed), such as: “Select a play: Run or Pass”; and receive selection of a predicted outcome (e.g., run or pass) from the user. Then, in response to initiation of gameplay, the remote computer system can lock the pre-play window and unlock a live-play window temporally aligned with initiation of gameplay in the video feed viewed by this user. During the live-play window, the remote computer system can transmit updates to the user in (near) real-time—as aligned with the video feed of the football game—indicating an actual outcome (e.g., run or pass) for this play and whether the predicted outcome selected by the user matches this actual outcome. The remote computer system can then selectively award the user a reward (e.g., point value) associated with the prompt and/or actual outcome of this play.

The remote computer system can cooperate with many instances of the native application to synchronize contest feeds to live games (e.g., football, basketball, baseball, soccer) viewed by many users (e.g., a small group of users, a large population of users). Thus, by temporally syncing each instance of the contest feed to a particular video feed of the game viewed by each user, the remote computer system can: independently lock and unlock pre-play and live-play windows for each instance of a contest feed to align with corresponding breaks in gameplay and/or initiation of gameplay in the live games viewed by each user; and inform users in (near) real-time—according to the live games viewed by these users—of correct and/or incorrect predictions submitted by each user and associated rewards. The remote computer system can therefore enable multiple users watching the same live game—in the same place or in different places (e.g., remotely)—to interact with each other around this particular game, thereby improving a viewing experience for a group of users, regardless of whether the group of users are together or remote.

By transmitting a game prompt to users for each play throughout a game—such as during a break in gameplay (e.g., during the pre-play window) before a next play is initiated—the remote computer system can increase user interest in each play, as the user has a vested interest in a particular outcome for each play. Further, by distilling gameplay into simple prompts (e.g., “Select: Pass or Run,” “Select: Right or Left,” and/or “Select: Loss or gain”) with a limited number of possible outcomes, the remote computer system can reduce a barrier to entry for users who may typically find gameplay overly complex or who may be less well-versed in the game. However, the remote computer system can increase engagement of all users—such as regardless of individual user knowledge of gameplay and its associated rules—by assigning a competitive value between users for every (or many, most) plays within the game, rewarding individual attentiveness to each play throughout the game, and enabling users to compete against each another (e.g., while viewing the game together or remotely) on accuracy of predictions of fundamental, easily-understood aspects of the game.

The remote computer system—in combination with a native application—is described herein as executing the method S100 to host a virtual contest feed corresponding to a live football game. However, the training apparatus 100 can similarly execute the method S100 to host virtual contest feeds for any type of sporting event such as baseball, basketball, soccer, tennis, multi-sport events, etc.

### 3. UI/UX

Generally, the remote computer system and local instances of the native application can cooperate to enable users to participate in a real-time sports contest. In one implementation, the remote computer system can host or interface with an instance of the native application (i.e., user portal)—executing on the user's computing device (e.g., mobile device, computer)—to configure a user profile for the user. For example, the user may download the native application to her smartphone and generate a new user profile. The user may manually populate the new user profile with various information, such as: name, display name (i.e., a username), age, time zone and/or geographic location (e.g., a region in which the user resides), contact information (e.g., email address, mobile phone number), etc.

The remote computer system can serve a contest feed, corresponding to a particular sporting event (e.g., a football game), to the user via an instance of the native application executing on the user's mobile device (e.g., mobile phone, tablet). For example, the user may wish to interact with a contest feed corresponding to a particular football game (e.g., a televised football game). To access the contest feed for this particular football game, the user may scan a QR code rendered on her television (e.g., on a television network televising the football game) with her mobile device. Alternatively, in another example, the user may enter a code (or “game code”) corresponding to the football game that the user wishes to follow. In yet another example, the remote computer system can render a selection interface (e.g., a scrollable menu rendered within the native application), from which the user may select the football game she wishes to follow. In response to receiving a selection of the particular football game from the user, the remote computer system can transmit the contest feed, corresponding to this particular football game, to the instance of the native application executing on the user's mobile device.

Further, the remote computer system can cooperate with instances of the native application to enable users to compete against other users in a real-time sports contest. For example, once the user has selected the contest feed corresponding to the football game she wishes to follow, the user may add a second user to the contest feed (e.g., via a scrollable menu within the contest feed). The remote computer system can then serve: a first instance of the contest feed to the initial user via a first instance of the native application executing on the first user's mobile device; and a second instance of the contest feed to the second user via a second instance of the native application executing on the second user's mobile device. The remote computer system can then cooperate with the first and second instances of the native application to: generate and transmit game prompts (e.g., pre-play, live-play, post-play) to both users throughout the football game; distribute rewards (e.g., points, currency) to both users based on their responses to these game prompts; and track rewards distributed to each user during the football game.

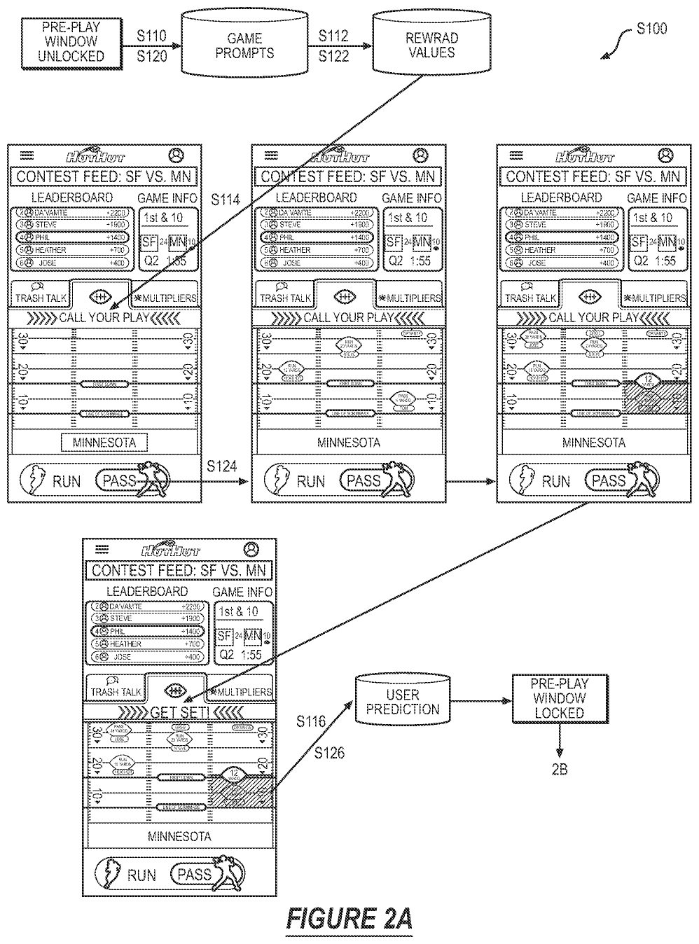

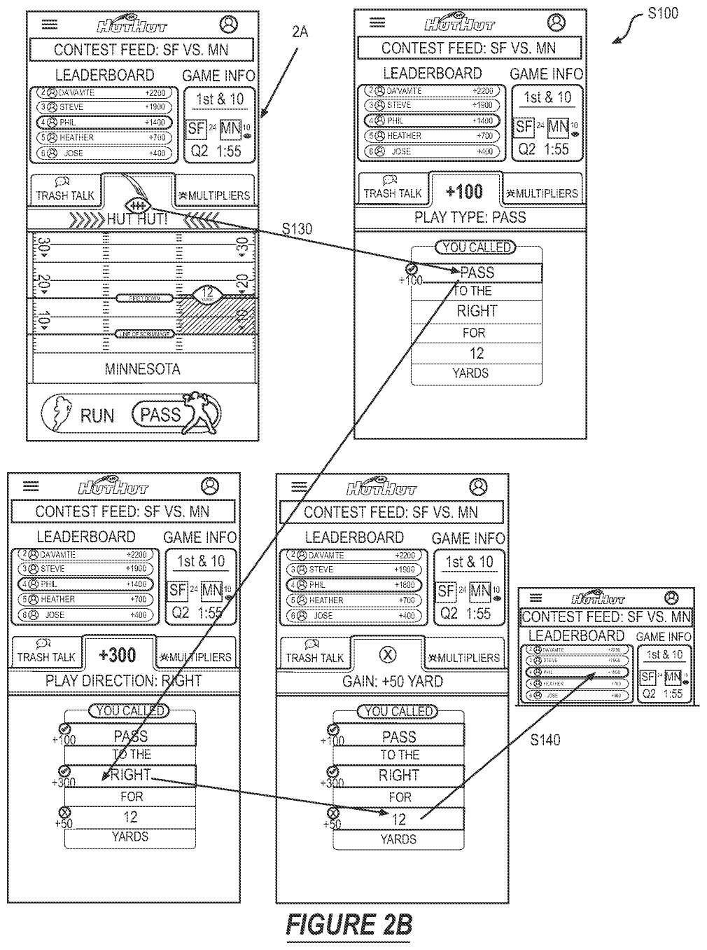

In one implementation, as shown in FIGS. 2A and 2B, the native application can render a football field (e.g., an animated football field), within the contest feed, configured to receive user selections of predicted outcomes responsive to game prompts. For example, prior to initiation of a next play, the native application can render a portion of an animated football field including a line of scrimmage, a first down marker, and a set of yard lines (e.g., 10-yard line, 20-yard line). The animated football field can be configured to receive user inputs and store these inputs as predicted outcomes for the next play. A user—accessing an instance of the native application on her smartphone—may then enter her prediction (i.e., predicted outcome) by touching (e.g., with her finger) a particular yard line and/or a particular region (e.g., left, right, or center) of the football field. Further, the native application can be configured to render selections input by other users (e.g., in a group of users competing against the user) on the animated football field—such as labelled with an icon (e.g., a football) and a username of each user—such that the user may view selections made by her competitors. In this example, the user may then select (e.g., with her finger) a particular icon associated with a selection (i.e., predicted outcome) of another user to comment and/or react to this selection, therefore encouraging communication between users and engagement within the native application for each play.

Additionally and/or alternatively, in another implementation, as shown in FIGS. 1, 2A and 2B, the native application can render a selection interface including a set of selectable icons configured to receive user selections of predicted outcomes responsive to game prompts. For example, prior to initiation of a next play, the native application can render a selection interface including a first icon corresponding to “run” and a second icon corresponding to “pass.” A user may then enter her prediction by selecting (e.g., with her finger) either the first icon or the second icon.

The native application can include also include a messaging portal configured to enable communication between users (e.g., via direct message) within instances of the native application while participating in the contest, thereby encouraging user engagement within the native application throughout the football game, such as during commercial breaks and/or during breaks in gameplay.

In one variation, the remote computer system can render a video feed of the sporting event for viewing by the user concurrently with the contest feed (e.g., within the native application). For example, the remote computer system can: render a video feed of a football game on an upper region of a display of the user's mobile device; and render the contest feed in a lower region of the display (e.g., such as when the user's mobile device is in portrait mode). Alternatively, in another example, the remote computer system can: render the video feed of the football game on the display of the user's mobile device; and render the contest feed overlaid the video feed of the football game (e.g., such as when the user's mobile device is in landscape mode). In this example, the contest feed can be configured to automatically disappear or relocate to a corner of the display during gameplay (i.e., during the play window).

### 4. Temporal Synchronization

In one variation, the remote computer system can sync the contest feed accessed by the user (e.g., within the native application executing on her mobile device) to a corresponding video feed of the football game viewed by the user (e.g., on her television). In particular, the remote computer system can temporally synchronize the contest feed to the corresponding video feed of the football game viewed by the user in order to account for delays in this video feed (e.g., due to broadcast delays or a poor Internet connection).

In one implementation, the remote computer system can identify a delay interval (i.e., lag) in the video feed of the football game viewed by the user and sync the contest feed served to the user (e.g., within the native application) to this video feed based on the delay interval. For example, a television network airing the football game can render a series of QR codes to the user on her television, each QR code in the series of QR codes linked to a particular timestamp. In response to the user scanning a first QR code, in the series of QR codes, the remote computer system can identify a first timestamp linked to the first QR code and therefore estimate a delay interval for the contest feed viewed by the user based on the first timestamp.

In another example, the remote computer system can estimate the delay interval based on an audio feed of the football game. In particular, in this example, the remote computer system can: access a user audio feed of the football game (e.g., output by the user's television) and record a two-second audio snippet of this user audio feed; extract an audio fingerprint from the two-second audio snippet; and record a first timestamp associated with the audio fingerprint. Then, the remote computer system can: access a corresponding fingerprint stored for a live video feed of the football game; and record a second timestamp associated with the corresponding fingerprint from the live video feed. The remote computer system can then estimate a delay interval (e.g., for the user watching the game on her television) based on a difference between the first and second timestamps. The remote computer system can then temporally synchronize distribution of the contest feed to the user (e.g., within the native application) with the video feed of the football game, watched by the user, based on the identified delay interval. Therefore, the remote computer system can lock and unlock the pre-play window—and thereby transmit game prompts to the user and receive predicted outcomes from the user—during appropriate breaks in game play as defined by the video feed of the game watched by the user.

In another implementation, the remote computer system can automatically lock and unlock the pre-play window for the user based on triggers detected in the audio feed of the football game. For example, the remote computer system can: access a live audio feed of the football game; record a first audio snippet (e.g., two-second audio snippet) at an end of a first play; extract a first audio fingerprint from the first audio snippet; record a second audio snippet (e.g., two-second audio snippet) at a start of a second play; and extract a second audio fingerprint from the second audio snippet. Further, the remote computer system can: access a user audio feed (e.g., output by the user's television) of the football game watched by the user; and, in response to detecting the first audio fingerprint in the user audio feed, unlock a pre-play window for this user. Then, in response to detecting the second audio fingerprint in the user audio feed, the remote computer system can automatically lock the pre-play window for this user. The remote computer system can therefore match unlocking and locking of the pre-play window for this particular user to the audio and/or video feed of the football game watched by the user.

In one implementation, the remote computer system can synchronize commercial breaks in a video feed of the live football game with mobile advertisements served to users in the native application. In particular, by synchronizing the video feed of the live football game viewed by the user with the instance of the contest feed accessed by the user within the native application, the remote computer system can: delineate commercial breaks in the video feed (e.g., via detection of audio content in the video feed, via manual input); and serve advertisements and/or promotional offers—matched to advertisements shown in the video feed of the football game—to the user, via the instance of the contest feed accessed by the user (e.g., within the native application), during these commercial breaks. Additionally, the remote computer system can cooperate with the native application to enable completion of e-commerce transactions associated with these advertisements and/or promotional offers. For example, the remote computer system can cooperate with an instance of a native application accessed by a user to: enable selection of (e.g., clicking on) advertisements and/or promotional offers served to the user within the native application; trigger initiation of an e-commerce transaction—within the native application—responsive to selection of a particular advertisement or promotional offer by the user; and retrieve user information (e.g., credit card information, shipping address) stored in a user profile for this user to enable completion of the e-commerce transaction and shipping of an associated product to the user. The user may therefore redeem offers and/or purchase products advertised in the video feed of the football game in real-time.

### 5. Pre-Play Window

Generally, the remote computer system can serve the user the contest feed (e.g., within the native application) including a series of game prompts (e.g., questions about a corresponding football game) delivered to the user throughout a corresponding football game. For example, the remote computer system can generate and deliver a game prompt to the user such as: “Will the next play be a passing or rushing play?”; “Will the offensive team score on this drive?”; “Will the offensive achieve a first down on this play?”; “Will there be a turnover on this play?”; and/or “Which receiver will the quarterback throw to if the next play is a passing play?”

In one implementation, the remote computer system unlocks a pre-play window prior to initiation of a play window (i.e., gameplay). During the pre-play window, the remote computer system can transmit a game prompt to the user (e.g., via the contest feed), the game prompt including a question and a set of possible outcomes corresponding to the question. For example, the remote computer system can generate a game prompt stating: “Will the offense pass or rush on the next play?” Further, the remote computer system can include a set of possible outcomes in the game prompt for selection by the user. In this example, the remote computer system can include a first icon labelled “rush” and a second icon labelled “pass,” the first and second icons configured to receive an input (e.g., touch, click, swipe) from the user. Alternatively, in another example, the remote computer system can generate a game prompt stating: “Swipe left for a passing play” and “Swipe right for a rushing play.” The game prompt can therefore be configured to receive user inputs (i.e., selections).

The remote computer system can initiate a timer at a start of the pre-play window for receiving selection of an outcome from the user. In response to expiration of the timer, the remote computer system can lock the pre-play window. The remote computer system can initiate the timer for a particular duration such that the time expires prior to initiation of the play window (i.e., gameplay). Alternatively, the remote computer system can automatically lock the pre-play window upon initiation of the play window.

For example, prior to a play window (e.g., during a break in gameplay), the remote computer system can: unlock the pre-play window; generate a first game prompt stating, “Swipe left for a passing play and swipe right for a rushing play”; transmit (i.e., render) the first game prompt to the user within the contest feed; and initiate a timer for a duration of the pre-play window (e.g., five seconds, fifteen seconds, thirty seconds) approximately concurrently transmitting the first pre-play question to the user. Then, in response to the user swiping left at her mobile device, the remote computer system can: store a first predicted outcome of “pass” for the user in a pre-play buffer; and, in response to expiration of the timer, lock the pre-play window and the predicted outcome of “pass” in the pre-play buffer. The remote computer system can then unlock the play window during which a first play (e.g., a passing play)—corresponding to the first game prompt—is executed.

### 5.1 Award

The remote computer system can then selectively award points to the user based on the predicted outcome (e.g., passing play or rushing play) selected by the user and the actual outcome executed during the play window (i.e., during gameplay). In the preceding example, in response to the actual outcome of the first play corresponding to a “passing play,” the remote computer system can award the user a set of points associated with the first game prompt based on the predicted outcome matching the actual outcome. In particular, in this example, the remote computer system can: access a reward (e.g., point quantity, dollar amount) assigned to the first game prompt; access the actual outcome executed during the play window; access the predicted outcome stored in the pre-play buffer; and, in response to the predicted outcome corresponding to the actual outcome, assign the award to the user. The remote computer system can then discard the predicted outcome from the pre-play buffer in preparation for a next pre-play window and a next prompt.

In one implementation, the remote computer system can track rewards earned by the user over a duration of the football game. For example, if a first and second user are participating in a contest corresponding to a live football game, the remote computer system can track rewards earned by each user throughout the game to select a “winner” once the contest is finished. In particular, for the first user, in response to a predicted outcome for particular game prompt matching an actual outcome of the play, the remote computer system can: access an assigned reward (e.g., 5 points, $1.00) for this game prompt; and update a first reward total for this user (e.g., stored in the user profile), for this contest, based on the assigned reward for this game prompt. The remote computer system can similarly track a second reward total for the second user. Then, once the contest is finished (e.g., when the corresponding live football game is finished), the remote computer system can: access both the first and second reward totals; and, in response to the first reward total exceeding the second reward total, select the first user as the winner of this contest.

In one implementation, the remote computer system can assign a particular reward (e.g., quantity of points, dollar value) to a game prompt and distribute this reward to the user if the predicted outcome by the user matches the actual outcome. For example, the remote computer system can assign a reward of ten points to the game prompt stating: “Swipe left for a passing play or swipe right for a rushing play.” In response to the user swiping left, the remote computer system can store a predicted outcome for the user as a passing play. Then, in response to the actual play corresponding to a passing play, the remote computer system can automatically reward the user ten points. Alternatively, in response to the actual play corresponding to a rushing play, the remote computer system can withhold the ten points from the user. In another implementation, the remote computer system can assign a particular reward to each individual outcome. For example, for the game prompt stating, “Swipe left for a passing play or swipe right for a rushing play,” the remote computer system can: assign a first point value (e.g., ten points) to a passing play; and assign a second point value (e.g., five points) to a rushing play. In this example, if the user correctly predicts the actual outcome, the remote computer system can distribute points to the user based on the corresponding point value for the actual outcome.

In one variation, the remote computer system can assign point values to particular outcomes based on statistics associated with the corresponding play. For example, if the next play is “3^{rd} and inches,” the remote computer system can access a database of statistics and estimate a likelihood that the offensive team will pass or rush on this play based on these statistics. In this example, the remote computer system can assign a higher point value to “rush” (e.g., ten points) and a lower point value to “pass” (e.g., five points) due a higher likelihood (e.g., historically) that the offensive team will “rush” on this play. Further, in this variation, the remote computer system can provide these statistics to the user in the contest feed within the pre-play window. In particular, in the preceding example, the remote computer system can transmit a notification to the user stating: “The team is 80% likely to rush the ball in this scenario.” Therefore, the user may decide whether to risk earning additional points by selecting the less likely outcome or to select the more likely scenario option and earn fewer points.

The remote computer system can transmit a notification to the user indicating whether the user correctly predicted the actual outcome of the play. Additionally and/or alternatively, in response to the user predicting the actual outcome, the remote computer system can include the corresponding award in the notification transmitted to the user. In one implementation, the remote computer system can transmit this notification to the user in (near) real-time during the play window. For example, during execution of the play within the play window, in response to identifying a passing play, the remote computer system can temporarily overlay a video feed of the football game (e.g., rendered within the native application executing on the user's mobile device) with a notification stating: “Passing play: +5 points.”

Alternatively, in another implementation, the remote computer system can transmit this notification and/or resolve award assignment after completion of the play. In this implementation, the remote computer system can: lock the play window in response to completion of the play; and initiate a post-play window. During the post-play window, the remote computer system can distribute awards and/or notifications to the user as described above. In this implementation, by waiting until after completion of the play to resolve award distribution and/or deliver notifications to the user, the remote computer system can minimize errors due to anomalies (e.g., replay of down, flag, call overturned). Further, the remote computer system can enable the user to watch the play in real-time with minimal distractions.

### 6. Pre-Play Variation: Multiple Game Prompts

In one variation, the remote computer system can transmit multiple game prompts to the user during the pre-play window. The remote computer system can assign each of these game prompts a particular reward (e.g., point value, dollar value). For example, during the pre-play window, the remote computer system can transmit a set of game prompts to the user including: “Rush or pass play?”; “Will there be a first down?”; and “How many yards gained?”. The user can then submit a predicted outcome for each prompt, in the set of game prompts or select a subset of game prompts, from the set of game prompts. The remote computer system can then implement the methods described above to distribute awards to the user based on the predicted and actual outcomes of the play associated with each prompt.

In one implementation, in which the native application can render a football field (e.g., animated football field) configured to receive selections of predicted outcomes from the user, the remote computer system can transmit a prompt to the user to select a predicted outcome of a next play by interacting with an instance of the football field rendered to the user (e.g., within an instance of the native application). For example, the remote computer system can transmit a prompt to the user to select a predicted outcome for the next play including a type of play (e.g., pass or run), a direction of play (e.g., right, left, or center) and/or a distance (e.g., 5 yards, 50 yards) of the next play. The user may then select a particular location on the football field (e.g., by touching a corresponding location on a display of her mobile device) corresponding to a particular direction of play and a particular yard line. In this example, the remote computer system can also prompt the user to select a type of play, such as a pass play or rush play. Then, in response to receiving these selections from the user, the remote computer system can store the predicted outcome for the user for the next play, such as “pass, left, 15 yards” or “run, right, 5 yards.” Finally, after completion of this play, the remote computer system can: access an actual outcome (e.g., pass, right, 5 yards) of the play; and calculate a score (i.e., reward) for the user for this play based on each component (e.g., type of play, direction, distance) of the predicted outcome and each component of the actual outcome.

In one implementation, the remote computer system can transmit a series of game prompts to the user, each subsequent prompt in the series of game prompts stemming from the previous prompt. For example, the remote computer system can transmit a first game prompt to the user stating: “Rush or pass play?” In response to the user selecting “pass,” the remote computer system can transmit a second game prompt to the user stating: “To which receiver?” In response to receiving a selection of a receiver from the user, the remote computer system can: transmit a third prompt stating “which route will the receiver run?”; and a fourth prompt stating “will there be an interception?” The computer system can then assign additional points (i.e., bonus points) to each predicted outcome matching an actual outcome of the play.

In one implementation, during the pre-play window, the remote computer system can render a set of icons (e.g., within the native application) configured to receive user selections of particular anomalies which may occur during gameplay. For example, the remote computer system can render a set of icons including: a first icon associated with an interception; a second icon associated with a fumble; a third icon associated with a sack; and a fourth icon associated with a touchdown. In this example, if the user selects the first icon—therefore predicting an interception on the next play—the remote computer system can distribute a reward (e.g., a set of bonus points) to the user if an interception occurs on the next play. However, if there is no interception on the next play, the remote computer system can instead penalize the user, such as by removing points from the user or locking the user out from participating in the next pre-play window. In one implementation, the remote computer system can serve different game prompts of various difficulty levels to different users (e.g., via instances of the native application). For example, the remote computer system can: serve a standard game prompt to users playing at a first difficulty level (e.g., standard level), such as to select a type of play (e.g., run or pass), a direction of play (e.g., right, center, left), and a distance (e.g., distance in yards, a particular yard line); and serve an advanced game prompt to users playing at a second difficulty level (e.g., advanced level), such as to select the type of play, the direction of play, the distance, a play route (e.g., flat, slant, comeback), a receiver who will catch the football, and/or a running back who will run the ball. The remote computer system can therefore modify instances of the contest feed for users who may be less well-versed in the game to reduce a barrier to entry to the game and/or modify instances of the contest feed for users who may be more well-versed in the game to reward increased attentiveness and/or understanding of the game, thereby increasing engagement of these users with the game.

### 7. Variation: Real-Time Game Play

In one variation, the remote computer system and local instances of the native application can cooperate to enable users to select additional gameplay scenarios during gameplay. In particular, in this variation, the remote computer system can: generate a game prompt (e.g., on the fly) based on actions (e.g., pass, rush, interception, fumble) occurring during execution of a play; and transmit this game prompt to the user in (near) real time, such that the user may input a predicted outcome prior to completion of the play.

For example, during a pre-play window, in response to receiving selection of a first predicted outcome (e.g., rush) from a user (e.g., via an instance of the contest feed), the remote computer system can: store this first predicted outcome for this user (e.g., in a buffer); and, in response to initiation of a next play, lock the pre-play window and unlock a live-play window. Then, in response to detecting a pass play and a ball trajectory greater than a threshold distance (e.g., 50 yards), the remote computer system can: notify the user of an actual outcome of this play (e.g., pass); transmit a prompt to the user to select a predicted outcome for this particular pass, such as “Select: Complete pass, incomplete pass, interception” prior to completion of the pass (e.g., while the ball is in the air); and, in response to receiving selection of a second outcome (e.g., complete pass) from the user prior to completion of the pass, store the second outcome for this user. In another example, in response to detecting a quarterback scramble, the remote computer system can transmit a game prompt to the user to select whether the quarterback will complete a pass, rush for a gain of yards, rush for a loss of yards, throw the ball away, or be sacked.

Therefore, the remote computer system can enable the user to continue engaging with the contest feed and football game throughout the entire play—regardless of whether the user accurately predicted the initial outcome—while potentially earning additional rewards.

### 8. Variation: Post-Play Game Play

In another variation, the remote computer system and local instances of the native application can cooperate to enable users to select additional gameplay scenarios post-gameplay. In particular, in this variation, the remote computer system can: detect an action or anomaly associated with a current play; initiate a post-play window after the current play is completed (e.g., before unlocking the pre-play window for a next play); and prompt the user to input a predicted outcome for a particular scenario associated with the current play. For example, in response to a flag on the play, the remote computer system can transmit a game prompt to the user stating: “What type of flag?”; “Which individual player received the flag?”; or “Offensive flag or defensive flag?”. In another example, in response to a touchdown scored during the play being under review, the remote computer system can transmit a game prompt to the user stating: “Caught or incomplete?” or “Touchdown stands or overturned?”.

Therefore, the remote computer system can increase engagement of the user with the game and/or contest feed throughout an entire play or game by encouraging users to carefully watch and/or review each play in exchange for potentially earning additional rewards. Similarly, by serving users prompts during a post-play window, the remote computer system can increase user engagement during breaks in gameplay, such as while a preceding play is under review, or during scheduled breaks.

### 9. Players

The remote computer system can cooperate with instances of the native application to enable competition between a set of users. For example, as described above, the remote computer system can enable a first and second user to both join a contest feed corresponding to a live football game. The remote computer system can then: initiate a contest between the first and second user; track a first score corresponding to the first user throughout the football game; and track a second score corresponding to the second user throughout the football game. Then, once the football game is finished, the remote computer system can: identify a “winner” of the contest based on the first score of the first user and the second score of the second user; and terminate this contest.

In one implementation, the remote computer system can cooperate with instances of the native application to enable a group of users to compete against each other user in the group. For example, the native application can be configured to enable a group of friends (e.g., five, ten, twenty users) to form a first group. In response to receiving selection of a football game from the group or from a user in the group, the remote computer system can then: prompt each user in the group to participate in a contest for this football game (e.g., via push notification, via message within the native application); and, in response to receiving confirmation of the contest from the first group, initiate the contest and transmit the contest feed for this contest to each user in the first group. Alternatively, in response to receiving confirmation of the contest from a subset of users in the first group, the remote computer system can initiate the contest and transmit the contest feed for this contest to each user in the subset of users.

Alternatively, in one implementation, the remote computer system can cooperate with instances of the native application to enables users to compete against a general population of users, a particular cohort of users (e.g., fans of a particular football team), and/or a random subset of users.

In one variation, the remote computer system can enable users to compete against a VIP player, such as: a professional football player, a retired football player, a sports anchor, a sports commentator, a celebrity, etc. In this variation, the remote computer system can transmit a VIP feed corresponding to the VIP player's selections throughout the game to users within the native application, alongside instances of the contest feed. For example, during a pre-play window, in response to transmitting a first game prompt to users (e.g., via instances of the native application), the remote computer system can transmit a selection of a first predicted outcome, selected by a VIP player, responsive to the first game prompt. A user may therefore consider the selection by the VIP player in selecting her own predicted outcome for the first game prompt, as the VIP player may have additional knowledge or be considered an expert on football. Alternatively, the remote computer system can transmit this selection of the first predicted outcome to the user after selection of a predicted outcome by the user, to compare her prediction to the VIP player's prediction.

In another variation, the remote computer system can enable users viewing a football game in-person (e.g., at the football stadium) to participate in a contest. For example, the remote computer system can cooperate with instances of the native application to form a “crowd” contest. In this example, the remote computer system can interface with a stadium display (e.g., a “jumbotron”) to: display game prompts and possible outcomes; highlight actual outcomes after play completion; display messages entered by users within the chat window; and/or display winners in the stadium (e.g., a list of the top ten users based on score). Additionally and/or alternatively, in this variation, the remote computer system can enable users viewing the game remotely (e.g., at home) to compete against users viewing the game in-person.

### 10. Variation: Baseball

In one variation, the remote computer system can similarly cooperate with instances of the native application to host a real-time baseball contest corresponding to a live baseball game. For example, prior to each pitch thrown by the pitcher, the remote computer system can: unlock a pre-play window; transmit a game prompt to the user to select a type of pitch the pitcher will throw (e.g., fastball, change-up, curveball, slider, drop-ball, knuckleball); receive a predicted pitch of a “curveball” from the user; and, in response to detecting the pitcher entering a particular pose (e.g., associated with initiating a pitch), lock the pre-play window. Then, after the pitch (e.g., after the ball crosses a plane over home plate), the remote computer system can: identify an actual pitch thrown by the pitcher as a “fastball”; compare the predicted pitch selected by the user to the actual pitch; and, in response to the predicted pitch differing from the actual pitch, withhold an award associated with the game prompt from the user for this pitch. The remote computer system can generate similar and/or multiple game prompts to transmit to the user during the pre-play period, such as: “Double play?” (e.g., when there is a runner on first base); “Hit; Bunt; Strike Out; Walk; Ground-out or Fly-out”; and/or “Hit: Right, Center, or Left?” (e.g., if the user initially selects “Hit”).

The remote computer system can also transmit game prompts to the user during live gameplay in (near) real time. For example, in response to detecting a hit that propels the ball along a plane of the foul ball line, the remote computer system can transmit a game prompt to the user to predict whether the ball will be “fair” or “foul.” In another example, in response to detecting a particular trajectory of the ball after a hit, the remote computer system can transmit a game prompt to the user to predict whether this hit will be a homerun.

The remote computer system can then similarly distribute rewards to the user throughout the baseball game based on these game prompts and/or track rewards distributed to this user according to the methods and techniques described above.

### 11. Variation: Basketball

In one variation, the remote computer system can similarly cooperate with instances of the native application to host a real-time basketball contest corresponding to a live basketball game. For example, prior to each start of the clock (e.g., initiation of live gameplay) the remote computer system can: unlock a pre-play window; and transmit a game prompt to the user to select a particular predicted outcome such as a next team to score, a next player to score, a duration until a next whistle, which team will win the tipoff, which player will receive the inbound ball, etc.; compare an actual outcome (e.g., home team won the tipoff) to a predicted outcome selected by the user (e.g., away team wins the tip off), and, in response to the predicted outcome differing from the actual outcome, withhold the reward from the user. Alternatively, in response to the actual outcome (e.g., shooting guard scored first) matching the predicted outcome selected by the user (e.g., shooting guard will score next), the remote computer system can distribute a reward associated with the game prompt to the user (e.g., at the user profile for this user). The remote computer system can generate and transmit multiple game prompts for selection by the user during the pre-play window as described above.

The remote computer system can similarly transmit game prompts to the user during live gameplay in (near) real time. For example, in response to a player shooting the basketball from beyond the three-point line, the remote computer system can transmit a game prompt to the user to predict whether the player will “miss” or “make” this shot. In another example, in response to detecting a fast-break play, the remote computer system can transmit a game prompt to the user to predict whether a player with the basketball will “dunk” the basketball.

The remote computer system can then similarly distribute rewards to the user throughout the basketball game based on these game prompts and/or track rewards distributed to this user according to the methods and techniques described above.

### 12. Variation: Simulated Sports Game

In one variation, the remote computer system can cooperate with instances of the native application to host a “real-time” sports contest corresponding to a simulated sports game (e.g., a simulated football game, baseball game, basketball game, or soccer game). For example, the remote computer system can leverage historical sports statistics (e.g., for a particular sport, a particular team, and/or a particular player) to generate (e.g., via artificial intelligence or other analysis techniques) a simulated sports game including simulated plays and/or simulated outcomes of plays. In this variation, the remote computer system can transmit game prompts to users and track user scores throughout the simulated sports game according to the methods and techniques described above. Therefore, the remote computer system can enable users to compete in an online sports contest—hosted by the remote computer system in conjunction with the native application—even in the absence of a live sports broadcast corresponding to a real, live sports game (e.g., a live football game).

### 13. Sports Betting Platform

In one variation, the remote computer system can cooperate with local instances of the native application to enable users to participate in a real-time sports betting contest. In particular, the remote computer system can enable betting (i.e., gambling) within the contest feed between users, such that the native application serves as an online sports betting platform.

In this variation, the remote computer system can: track rewards (e.g., financial awards) distributed to a particular user throughout a contest (e.g., associated with a live football game); and identify a payout to this particular user upon completion of the contest based on these rewards. For example, the remote computer system can assign a reward value (e.g., point value, dollar value) to each prompt and/or type of prompt (e.g., pre-play, live-play, post-play) distributed to the user. Alternatively, the remote computer system can enable users (e.g., a group of users participating in a contest together) to select reward values associated with specific game prompts and/or types of game prompts before initiating a contest. Throughout the contest, the remote computer system can: distribute game prompts to the user to select predicted outcomes (e.g., rush, pass) for each play and/or various plays throughout the contest; and selectively distribute rewards assigned to these game prompts to the user responsive to the user selecting predicted outcomes matching actual outcomes of these plays.

In particular, in this example, in response to a predicted outcome matching an actual outcome of the play, the remote computer system can: access an assigned reward value (e.g., 5 points, $1.00) for the corresponding prompt; and update a total reward value for this user (e.g., stored in the user profile), for this contest, based on the assigned reward value. Then, once the contest is finished (e.g., when the corresponding live football game is finished), the remote computer system can: access the total reward value (e.g., 250 points, $25) for this user; access a central transaction account for this contest; access a user transaction account stored in the user profile; and distribute a financial award (e.g., dollar amount) equivalent to the total reward value for this user for this contest from the central transaction account to the user transaction account. Alternatively, if the user is playing in a contest with a group of friends, the remote computer system can: access a user transaction account for each user in the group; and automatically distribute appropriate financial awards to and from each user transaction account to settle the (final) total rewards of each user for this contest.

In this variation, the remote computer system can cooperate with instances of the native application to generate financial accounts for users for distribution and/or collection of financial awards. For example, during setup of a user profile for a user, the remote computer system can transmit a prompt (e.g., via an instance of the native application executing on the user's mobile device) to setup a transaction account for this user. Once the transaction account is setup, the remote computer system can store this transaction account in the user profile for this user. The user may then access this transaction account to deposit and withdraw funds for participating in and/or earned during contests.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for hosting a real-time sports contest comprising:
during a contest period associated with a live sporting event:
transmitting a contest feed to a user via an instance of a user portal executing on a mobile device accessed by the user, the contest feed associated with a sporting event; and
tracking a score of the user based on user interactions with the contest feed;
during a pre-play window within the contest period:
generating a first game prompt to select a first predicted outcome, from a first set of outcomes, for execution within the live sporting event, during a live-play window succeeding the pre-play window;
assigning the first game prompt a first reward value;
transmitting the first game prompt to the user within the contest feed via the user portal; and
in response to receiving selection of a first predicted outcome, from the first set of outcomes, prior to expiration of the pre-play window, storing the first predicted outcome for the first user; and
during the live-play window succeeding the pre-play window and within the contest period:
identifying a first actual outcome, from the first set of outcomes, executed within the live sporting event during the live-play window; and
in response to the first predicted outcome corresponding to the first actual outcome, updating the score of the user based on the first reward value.

2. The method of claim 1, further comprising:
in response to receiving selection of the first predicted outcome, from the first set of outcomes, prior to expiration of the pre-play window:
generating a second game prompt to select a subsequent predicted outcome, from a second set of outcomes, based on the first predicted outcome, for execution within the live sporting event, during the live-play window;
assigning to the second game prompt a second reward value; transmitting the second game prompt to the user within the contest feed via the user portal; and
in response to receiving selection of a second predicted outcome, from the second set of outcomes, prior to expiration of the pre-play window, storing the second predicted outcome for the first user; and
in response to the first predicted outcome and the second predicted outcome corresponding to the first actual outcome and the second actual outcome, updating the score of the user based on the first reward value and the second reward value.
